(19) United States
(12) Patent Application Publication
(10) Pub. No.: US 2025/0353033 A1
(43) Pub. Date: Nov. 20, 2025

(54) DROPLET EJECTING DEVICE

(71) Applicant: Panasonic Intellectual Property Management Co., Ltd., Osaka (JP)

(72) Inventors: ATSUSHI MAKIMOTO, Osaka (JP); KAZUKI FUKADA, Osaka (JP); TAKASHI INOUE, Osaka (JP); HIDEHIRO YOSHIDA, Osaka (JP)

(21) Appl. No.: 19/283,412

(22) Filed: Jul. 29, 2025

Related U.S. Application Data
(63) Continuation of application No. PCT/JP2023/043570, filed on Dec. 6, 2023.

(30) Foreign Application Priority Data
Feb. 16, 2023 (JP) 2023-022509

(51) Int. Cl. B05C 5/02; B05C 19/04

(52) U.S. Cl. CPC B05C 5/0291; B05C 19/04

(57) ABSTRACT

Droplet ejecting device (1) includes liquid chamber (12) that stores a liquid to be ejected from nozzle (10) inside, and plunger (11) that advances and retracts inside liquid chamber (12). A distance between a distal end of plunger (11) and a bottom surface inside liquid chamber (12) is larger than a maximum distance between a side surface of plunger (11) and an inner surface of liquid chamber (12) at a position where plunger (11) advances most toward nozzle (10).

### TECHNICAL FIELD

The present disclosure relates to a droplet ejecting device.

### BACKGROUND ART

In recent years, reduction in size and weight of electronic devices has been attempted, and reduction in size and weight of electronic components mounted on the electronic devices has been advanced. For example, a component having an implementation dimension of 400 μm×200 μm, which is called a “0402 component” capable of greatly reducing an implementation area, has been mounted on the electronic devices since around 2005.

The 0402 component is currently implemented by solder printing using a metal plate, but there is a problem that it is necessary to devise half etching or the like when the 0402 component is mixed with a large component. In addition, there is also a problem that it is required to individually control an application amount (application thickness). Thus, the implementation by printing has a poor yield. Further, there is a case where restriction is imposed on component arrangement in order to ensure printability.

In a droplet ejecting device using a reciprocating plunger, since a liquid material can be controlled by an operation of the plunger, these problems do not occur. However, this type of device has a problem that, when the plunger abuts on an inner wall of a liquid chamber, solder particles are crushed, and the crushed particles are clogged in a nozzle. As a result, the solder particles cannot be ejected.

Therefore, as the droplet ejecting device of the related art, there is the droplet ejecting device using the reciprocating plunger that can eject a small amount of droplets without the plunger abutting on the inner wall of the liquid chamber (see, for example, PTL 1).

### CITATION LIST

### Patent Literatures

PTL 1: Japanese Patent No. 6177291

### SUMMARY OF THE INVENTION

An aspect of a droplet ejecting device according to the present disclosure includes a liquid chamber that is comprised to store a liquid to be ejected from a nozzle inside, and a plunger that advances and retracts inside the liquid chamber. The liquid contains particles. A distance between a distal end of the plunger and a bottom surface inside the liquid chamber is larger than a maximum distance between a side surface of the plunger and an inner surface of the liquid chamber at a position where the plunger advances most toward the nozzle.

### BRIEF DESCRIPTION OF THE DRAWINGS

FIG. 1A is a sectional view illustrating an example of a configuration in which a plunger of droplet ejecting device 1 is positioned at a displacement start end.

FIG. 1B is a sectional view illustrating an example of a configuration in which the plunger of droplet ejecting device 1 is positioned at a displacement terminal end.

FIG. 2A is a partial sectional view illustrating a valve mechanism in which plunger 11 indicated by broken line C in FIG. 1A is positioned at the displacement start end.

FIG. 2B is a partial sectional view illustrating a valve mechanism in which plunger 11 indicated by broken line C in FIG. 1B is positioned at the displacement termination end.

FIG. 3 is a sectional view illustrating plunger 31 according to Modification 1.

FIG. 4 is a sectional view illustrating plunger 41 according to Modification 2.

FIG. 5 is a sectional view illustrating plunger 51 according to Modification 3.

FIG. 6 is a sectional view illustrating valve mechanism 61 according to Modification 4.

FIG. 7 is a sectional view illustrating liquid chamber 71 according to Modification 5.

### DESCRIPTION OF EMBODIMENT

In the configuration of PTL 1, the plunger does not abut on the inner wall of the liquid chamber. However, as a result, the solder is crushed, and there is a problem that an ejection amount varies due to variation in a mixing amount of air or the like when the droplet ejecting device is filled with a fluid, a change with time, and a change in physical property value such as viscosity of the fluid due to an application environment.

The reason is that it is necessary to increase a pressure in the liquid chamber in order to eject the solder without the plunger abutting on the inner wall of the liquid chamber near the nozzle, it is necessary to reduce a clearance between the plunger and the inner wall of the liquid chamber near the nozzle to ⅓ to 1/10 times at a high speed to compress the solder, and it is necessary to generate a fluid resistance effect by approaching the inner wall of the liquid chamber near the nozzle to 100 μm or less and narrowing down the inner wall of the liquid chamber near the nozzle in order not to release a high pressure from near the nozzle. At this time, since a surface constituting a throttle at a distal end of the plunger is displaced with a direction component perpendicular to the inner wall of the liquid chamber, a force of crushing the solder particles acts on the inner wall of the liquid chamber, and the solder particles are crushed.

The present disclosure has been made to solve such a problem, and an object of the present disclosure is to provide a droplet ejecting device capable of ejecting solder particles without being crushed, controlling displacement of a plunger to adjusting an ejection amount, and controlling a small amount of droplet ejection amount in a configuration in which a pressure necessary for ejection is generated while the plunger is displaced in a direction in which the plunger does not abut on an inner wall of a liquid chamber near a nozzle and a force of crushing the solder particles hardly acts on the inner wall of the liquid chamber, and a throttle for preventing the pressure from being released is provided.

Hereinafter, an exemplary embodiment of the present disclosure will be described with reference to the drawings. Note that, the exemplary embodiment to be described below each illustrates one specific example of the present disclosure. The following exemplary embodiment provides numerical values, constituent elements, arrangement position and connection states of the constituent elements, steps and order of the steps, and the like, which are merely exemplified and are not intended to limit the present disclosure. Accordingly, among the constituent elements in the exemplary embodiment below, a constituent element not described in an independent claim will be described as an optional constituent element.

In addition, each of the drawings is a schematic diagram, and is not necessarily strictly illustrated. Note that, in each of the drawings, substantially the same configurations are denoted by the same reference marks to eliminate or simplify duplicated description.

### Exemplary Embodiment

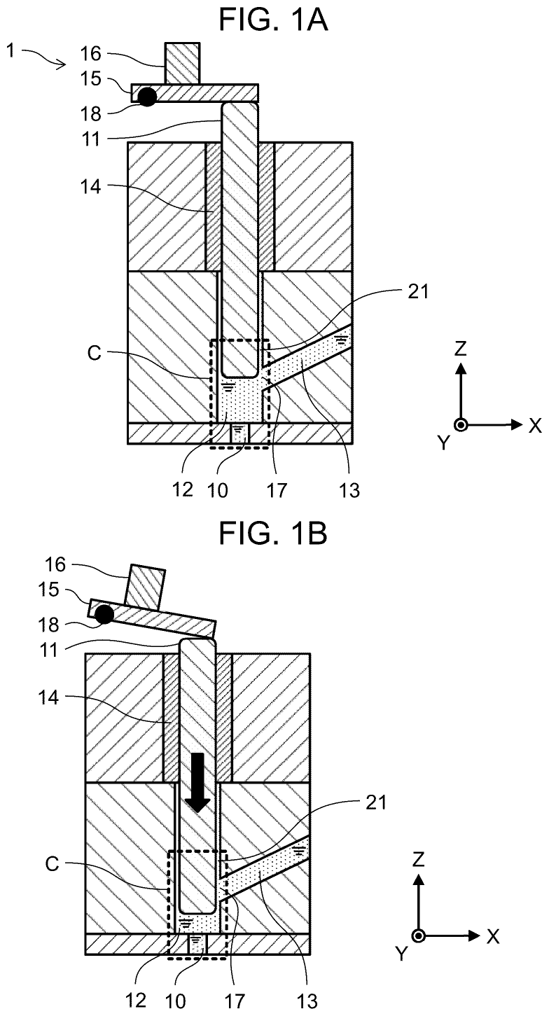

First, a configuration of droplet ejecting device 1 according to an exemplary embodiment will be described with reference to FIGS. 1A and 1B. FIG. 1A is a sectional view illustrating an example of a configuration in which plunger 11 of droplet ejecting device 1 is positioned at a displacement start end, and FIG. 1B is a sectional view illustrating an example of a configuration in which plunger 11 of droplet ejecting device 1 is positioned at a displacement termination end.

Droplet ejecting device 1 includes nozzle 10, plunger 11, liquid chamber 12, supply path 13, guide 14, displacement expanding mechanism 15, and actuator 16.

Nozzle 10 has an ejection port and ejects a liquid. The liquid contains particles such as solder particles. Nozzle 10 is arranged on a bottom surface of a space that is provided inside liquid chamber 12 and stores a fluid. A shape of nozzle 10 may be a cylinder, a cone, or a rectangular parallelepiped.

Plunger 11 advances and retracts in a Z direction in FIGS. 1A and 1B to generate a pressure change in liquid chamber 12. In addition, plunger 11 can increase or decrease a flow resistance with respect to a liquid flowing from supply path 13 into liquid chamber 12 or a liquid flowing from liquid chamber 12 into supply path 13 by advancing and retracting in the Z direction.

Thus, for example, as illustrated in FIGS. 1A and 1B, when plunger 11 is displaced at a high speed in a −Z direction, a liquid inside liquid chamber 12 is compressed to increase a pressure.

In addition, at a position where plunger 11 advances most toward nozzle 10 (displacement termination end position), a distance between a distal end of plunger 11 and a bottom surface inside liquid chamber 12 is larger than a maximum distance between a side surface of plunger 11 and an inner surface of liquid chamber 12.

As a result, a flow resistance of a liquid flowing out from the inside of liquid chamber 12 to supply path 13 is increased to make it difficult for the liquid to flow out, and thus, it is possible to prevent a decrease in the pressure inside liquid chamber 12.

Here, plunger 11 is arranged to pass through the inside of liquid chamber 12, but does not abut on an inner wall of liquid chamber 12 and maintains a gap (clearance) of a certain distance or more. In the case of a particle-containing ink, a size of the gap is larger than or equal to a particle diameter. Note that, when ink is not the particle-containing ink, a thickness may be larger than or equal to 2 μm. A shape of plunger 11 may be a polygonal prism such as a quadrangular prism or a hexagonal prism in addition to the cylinder.

In addition, in order to obtain the above effect, an opening degree of an opening connecting the inside of liquid chamber 12 and supply path 13 is changed between a case where plunger 11 is at a position of the displacement start end and the case where the plunger is at a position of the displacement termination end.

That is, an area where the side surface of plunger 11 covers an opening at the position where plunger 11 advances most toward nozzle 10 (a position of the displacement termination end) is larger than an area where the side surface of plunger 11 covers an opening at a position other than the position where plunger 11 advances most toward nozzle 10.

Liquid chamber 12 stores a liquid ejected from nozzle 10 inside. Liquid chamber 12 has a function of compressing the liquid to increase the pressure and maintaining a pressure necessary for ejecting the liquid from nozzle 10 together with the displacement of plunger 11. In addition, liquid chamber 12 is connected to supply path 13.

Supply path 13 has a function of supplying a liquid into liquid chamber 12. In order to supply particles to liquid chamber 12 without precipitating the particles, supply path 13 is formed to be perpendicular to a direction (−Z direction) in which the liquid is ejected from nozzle 10 or to be inclined to a bottom surface side where nozzle 10 is provided inside liquid chamber 12.

Guide 14 abuts on plunger 11 to regulate displacement in a direction perpendicular to the direction in which the liquid is ejected from nozzle 10 (a direction parallel to an XY plane), and thus, plunger 11 is prevented from abutting on the inner wall of liquid chamber 12.

Displacement expanding mechanism 15 rotates about fulcrum 18 about a Y-axis to expand the displacement of actuator 16 and displace plunger 11. Displacement expanding mechanism 15 is made of a material and a shape having rigidity such that the displacement of actuator 16 is expanded and plunger 11 can be continuously displaced even though the displacement is transmitted and plunger 11 receives a reaction force from the liquid stored inside liquid chamber 12 when the plunger is displaced.

Actuator 16 transmits the displacement to displacement expanding mechanism 15 to displace plunger 11 in an advancing and retracting direction (Z-axis direction) of plunger 11. In order to obtain high responsiveness, actuator 16 desirably uses, for example, a piezoelectric element. In addition, actuator 16 is not limited to the piezoelectric element, and may be displaced by another means such as an electromagnetic valve and a spring.

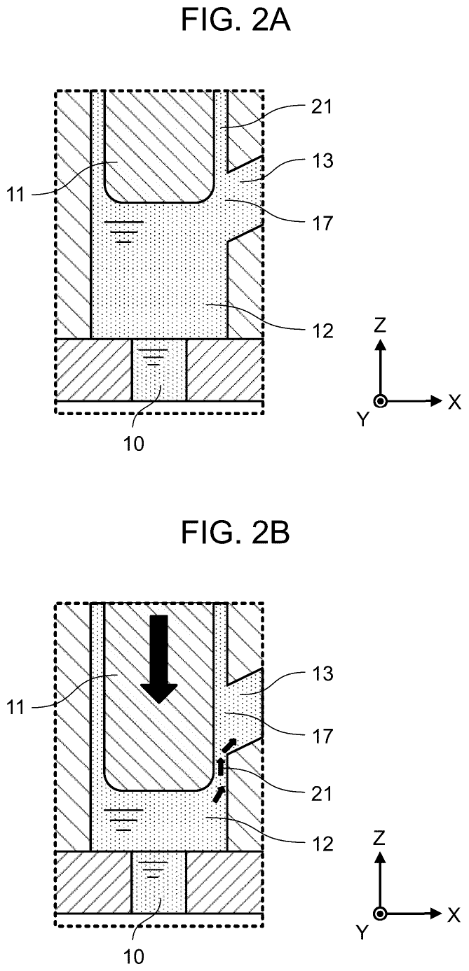

FIG. 2A is a partial sectional view illustrating a valve mechanism in which a portion of plunger 11 surrounded by broken line C in FIG. 1A is positioned at the displacement start end. FIG. 2B is a partial sectional view illustrating a valve mechanism in which the portion of plunger 11 surrounded by broken line C in FIG. 1B is positioned at the displacement terminal end.

Plunger 11 is displaced in the −Z direction, and thus, the liquid stored in liquid chamber 12 is compressed to generate a pressure necessary for ejection. In addition, the decrease in the pressure inside liquid chamber 12 is suppressed by reducing an opening degree of an opening 17 to increase the flow resistance for the liquid flowing out from the inside of liquid chamber 12 to supply path 13.

Although the flow resistance for suppressing the decrease in the pressure is formed by gap 21 between the inner wall of liquid chamber 12 around opening 17 and plunger 11, since a displacement direction of plunger 11 is not perpendicular to a wall surface of liquid chamber 12 forming gap 21, a force for pressing particles in the liquid against the wall surface of liquid chamber 12 is not generated, and particles such as solder particles are not crushed.

In addition, as illustrated in FIG. 2B, at the position where plunger 11 advances most toward nozzle 10 (displacement termination end position), the distance between the distal end of plunger 11 and the bottom surface inside liquid chamber 12 is larger than the maximum distance between the side surface of plunger 11 and the inner surface of liquid chamber 12. Thus, as indicated by an arrow in FIG. 2B, it is possible to suppress the particles from flowing from liquid chamber 12 to supply path 13 through gap 21.

By these series of effects, it is possible to increase a pressure of the liquid stored in liquid chamber 12 without crushing particles such as solder particles, prevent a decrease in the pressure after the pressure is increased, and stably eject the particle-containing liquid from nozzle 10.

Further, in the present disclosure, since the pressure in liquid chamber 12 continues to be high until plunger 11 is displaced in a +Z direction after the pressure in liquid chamber 12 is increased by the displacement of plunger 11 in the −Z direction, the fluid can be continuously ejected from the nozzle. Thus, an application amount of the fluid ejected from nozzle 10 can be controlled by controlling a time from when plunger 11 is displaced in the −Z direction to when the plunger is displaced in the +Z direction.

As a result, even though a change in a physical property value such as viscosity of the fluid due to a change with time or an application environment occurs in addition to a variation in a mixing amount of air or the like when the droplet ejecting device is filled with the fluid, application of a desired ejection amount can be realized by controlling the displacement of plunger 11 by a waveform of a voltage applied to actuator 16 including the piezoelectric element.

### Modification 1

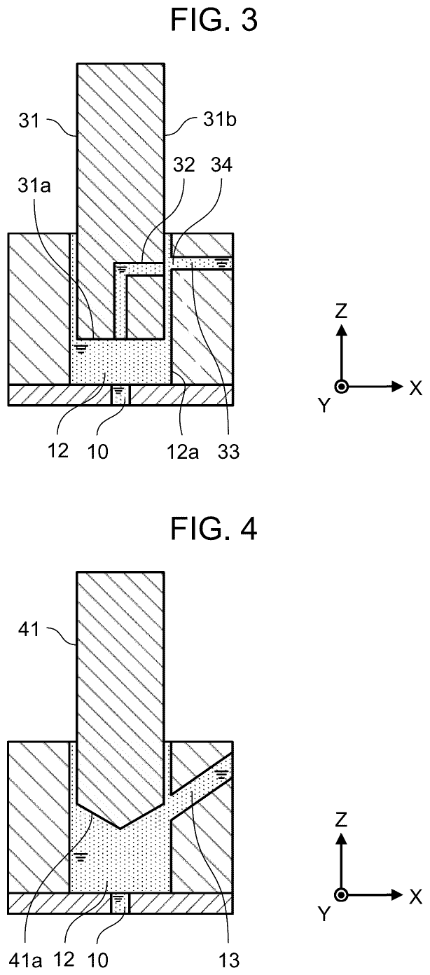

Next, another shape of plunger 31 according to Modification 1 will be described with reference to FIG. 3. FIG. 3 is a sectional view illustrating plunger 31 according to Modification 1. The same configurations as those in the exemplary embodiment are assigned with the same reference marks, and descriptions thereof are omitted.

Communication flow path 32 is formed in plunger 31. Communication flow path 32 is formed at a center of plunger 31 with a constant length in the Z direction from distal end 31a of plunger 31. Communication flow path 32 is formed up to side surface 31b of plunger 31 in an X-axis direction with a portion opposite to distal end 31a of plunger 31 changing an orientation at a right angle. Note that, here, communication flow path 32 is bent at a right angle, but may be bent at any angle other than the right angle.

In addition, a shape of communication flow path 32 on a surface of distal end 31a of plunger 31 is circular, but is not limited to the circular shape, and may be a square or another shape. The same applies to a shape of side surface 31b of flow path 32. Supply path 33 is formed in an +X direction from inner surface 12a of liquid chamber 12, and is connected to inner surface 12a of liquid chamber 12 through opening 34.

At a displacement termination end position of plunger 31, a distance between the distal end of plunger 31 and the bottom surface inside liquid chamber 12 is larger than a maximum distance between the side surface of plunger 31 and the inner surface of liquid chamber 12.

As a result, the flow resistance of the liquid flowing out from the inside of liquid chamber 12 to supply path 33 is increased to make it difficult for the liquid to flow out, and thus, it is possible to prevent a decrease in the pressure inside liquid chamber 12.

In addition, an area where the side surface of plunger 31 covers opening 34 at a position where plunger 31 advances most toward nozzle 10 is larger than an area where the side surface of plunger 31 covers opening 34 at a position other than the position where plunger 31 advances most toward nozzle 10.

Specifically, plunger 31 is displaced to the displacement termination end position from a state where communication flow path 32 and opening 17 are at the same height, and thus, plunger 31 suppresses the decrease in the pressure inside liquid chamber 12 by reducing the opening degree of opening 17. In addition, even in a case where bubbles are generated in liquid chamber 12, the bubbles can be easily removed by plunger 31.

### Modification 2

Next, another shape of plunger 41 according to Modification 2 will be described with reference to FIG. 4. FIG. 4 is a sectional view illustrating plunger 41 according to Modification 2. The same configurations as those in the exemplary embodiment are assigned with the same reference marks, and descriptions thereof are omitted.

Distal end 41a of plunger 41 is formed in a conical shape. Note that, distal end 41a of plunger 41 is not limited to the conical shape, and may have another shape such as a polygonal pyramid or a hemisphere.

At a displacement termination end position of plunger 41, a distance between the distal end of plunger 41 and the bottom surface inside liquid chamber 12 is larger than a maximum distance between a side surface of plunger 31 and the inner surface of liquid chamber 12.

As a result, a flow resistance of a liquid flowing out from the inside of liquid chamber 12 to supply path 13 is increased to make it difficult for the liquid to flow out, and thus, it is possible to prevent a decrease in the pressure inside liquid chamber 12.

In addition, an area where the side surface of plunger 41 covers opening 13 at a position where plunger 41 advances most toward nozzle 10 is larger than an area where the side surface of plunger 41 covers opening 13 at a position other than the position where plunger 41 advances most toward nozzle 10.

Specifically, plunger 41 is displaced to the displacement termination end position to change from a state where opening 13 is not covered with conical distal end 41a to a state where opening 13 is covered with the side surface of plunger 41, and thus, the plunger suppresses the decrease in the pressure inside liquid chamber 12 by reducing the opening degree of opening 17. In addition, since plunger 41 disperses the pressure, it is possible to prevent the particles from being crushed.

### Modification 3

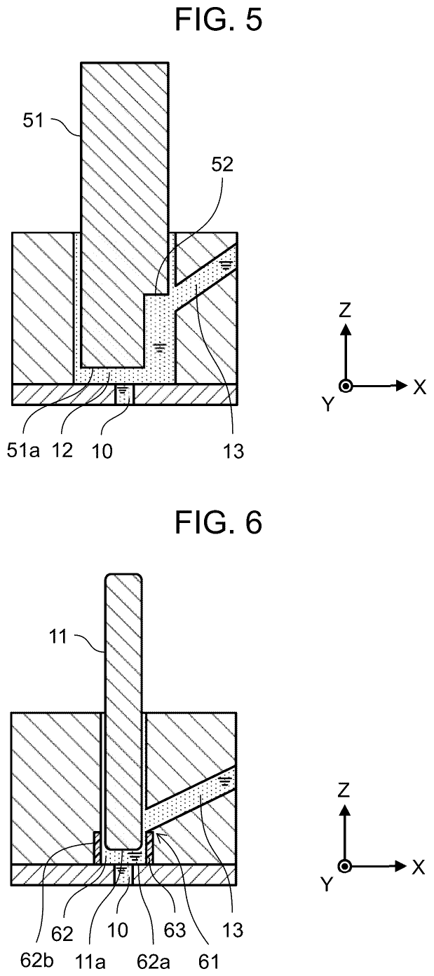

Next, another shape of plunger 51 according to Modification 3 will be described with reference to FIG. 5. FIG. 5 is a sectional view illustrating plunger 51 according to Modification 3. The same configurations as those in the exemplary embodiment are assigned with the same reference marks, and descriptions thereof are omitted.

Notch 52 is formed on a side surface of plunger 51 on supply path 13 side at distal end 51a of plunger 51.

A shape of notch 52 is a rectangular shape as viewed from a direction perpendicular to the Y-axis. Note that, the shape of notch 52 is not limited thereto, and may be another shape.

At a displacement termination end position of plunger 51, a distance between the distal end of plunger 51 and the bottom surface inside liquid chamber 12 is larger than a maximum distance between the side surface of plunger 51 and the inner surface of liquid chamber 12. Here, the side surface of plunger 51 is a side surface on which notch 52 is not formed.

As a result, a flow resistance of a liquid flowing out from the inside of liquid chamber 12 to supply path 13 is increased to make it difficult for the liquid to flow out, and thus, it is possible to prevent a decrease in the pressure inside liquid chamber 12.

In addition, an area where the side surface of plunger 51 covers opening 13 at a position where plunger 51 advances most toward nozzle 10 is larger than an area where the side surface of plunger 51 covers opening 13 at a position other than the position where plunger 51 advances most toward nozzle 10.

Specifically, plunger 51 is displaced to the displacement termination end position to change from a state where opening 13 is not covered with notch 52 to a state where opening 13 is covered with the side surface of plunger 51, and thus, the plunger suppresses the decrease in the pressure inside liquid chamber 12 by reducing the opening degree of opening 17.

### Modification 4

Next, valve mechanism 61 according to Modification 4 will be described with reference to FIG. 6. FIG. 6 is a sectional view illustrating valve mechanism 61 according to Modification 4. The same configurations as those in the exemplary embodiment are assigned with the same reference marks, and descriptions thereof are omitted.

Valve mechanism 61 has elastic body 63 installed to cover side surface 62b on bottom surface 62a inside liquid chamber 62. Distal end 11a of plunger 11 is inserted with a gap inside elastic body 63. Elastic body 63 is rubber or the like, but is not limited to rubber or the like, and may be another elastic body. Elastic body 63 is provided in valve mechanism 61, and thus, solder collapse can be prevented.

At the displacement termination end position of plunger 11, a distance between the distal end of plunger 11 and bottom surface 62a inside liquid chamber 62 is larger than a maximum distance between the side surface of plunger 11 and an inner surface of liquid chamber 62, which is a surface of elastic body 63.

As a result, a flow resistance of a liquid flowing out from an inside of liquid chamber 62 to supply path 13 is increased to make it difficult for the liquid to flow out, and thus, it is possible to prevent a decrease in a pressure inside liquid chamber 62.

In addition, an area where the side surface of plunger 11 covers opening 13 at the position where plunger 11 advances most toward nozzle 10 is larger than an area where the side surface of plunger 11 covers opening 13 at a position other than the position where plunger 11 advances most toward nozzle 10.

Specifically, plunger 11 is displaced to the displacement termination end position to change from a state where opening 13 is not covered with the side surface of plunger 11 to a state where opening 13 is covered with the side surface of plunger 11, and thus, the plunger suppresses the decrease in the pressure inside liquid chamber 62 by reducing the opening degree of opening 13.

### Modification 5

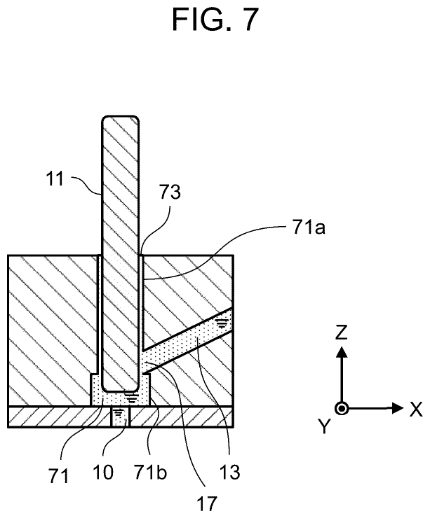

Next, another shape of liquid chamber 71 according to Modification 5 will be described with reference to FIG. 7. FIG. 7 is a sectional view illustrating liquid chamber 71 according to Modification 5. The same configurations as those in the exemplary embodiment are assigned with the same reference marks, and descriptions thereof are omitted.

Liquid chamber 71 has side surface 71a arranged above opening 17 of supply path 13 and side surface 71b arranged below opening 17 of supply path 13. Side surface 71b of liquid chamber 71 arranged below opening 17 of supply path 13 is formed to be wider than side surface 71a.

As a result, the particles can easily escape, and it is possible to suppress the particles from gathering at one place and crushing the particles.

At the displacement termination end position of plunger 11, a distance between the distal end of plunger 11 and a bottom surface inside liquid chamber 71 is larger than a maximum distance between the side surface of plunger 11 and an inner surface of liquid chamber 71, which is side surface 71a.

As a result, a flow resistance of a liquid flowing out from an inside of liquid chamber 71 to supply path 13 is increased to make it difficult for the liquid to flow out, and thus, it is possible to prevent a decrease in a pressure inside liquid chamber 71.

In addition, an area where the side surface of plunger 11 covers opening 13 at the position where plunger 11 advances most toward nozzle 10 is larger than an area where the side surface of plunger 11 covers opening 13 at a position other than the position where plunger 11 advances most toward nozzle 10.

Specifically, plunger 11 is displaced to the displacement termination end position to change from a state where opening 13 is not covered with side surface 71a of plunger 11 to a state where opening 13 is covered with the side surface of plunger 11, and thus, the plunger suppresses the decrease in the pressure inside liquid chamber 12 by reducing the opening degree of opening 13.

According to the present disclosure, the particle-containing fluid can be ejected without crushing the particles.

### INDUSTRIAL APPLICABILITY

The technology of the present disclosure can be widely used in a droplet ejecting device capable of ejecting solder particles without crushing the solder particles, controlling displacement of a plunger to adjust an ejection amount, and controlling a small amount of droplet ejection amount.

### REFERENCE MARKS IN THE DRAWINGS

1 droplet ejecting device
10 nozzle
11 plunger
12 liquid chamber
13 supply path
14 guide
15 displacement expanding mechanism
16 actuator
17 opening
18 fulcrum

1. A droplet ejecting device comprising:
a liquid chamber that is comprised to store a liquid to be ejected from a nozzle inside, the liquid containing particles; and
a plunger that advances and retracts inside the liquid chamber,
wherein a distance between a distal end of the plunger and a bottom surface inside the liquid chamber is larger than a maximum distance between a side surface of the plunger and an inner surface of the liquid chamber at a position where the plunger advances most toward the nozzle.

2. The droplet ejecting device according to claim 1, further comprising a supply path that has an opening in the inner surface of the liquid chamber and is comprised to supply the liquid into the liquid chamber,
wherein an area where the side surface of the plunger at a position where the plunger advances most toward the nozzle covers the opening is larger than an area where the side surface of the plunger at a position other than the position where the plunger advances most toward the nozzle covers the opening.

3. The droplet ejecting device according to claim 2, wherein the plunger has a flow path communicating from the distal end of the plunger to the side surface of the plunger, the flow path extending in an advancing and retracting direction of the plunger from the distal end of the plunger and bent toward the side surface of the plunger.

4. The droplet ejecting device according to claim 1, wherein a distance between the side surface of the plunger and the inner surface of the liquid chamber is larger than a particle diameter of the particles in the liquid.

5. The droplet ejecting device according to claim 1, further comprising:
an actuator that displaces the plunger in an advancing and retracting direction of the plunger; and
a displacement expanding mechanism that expands the displacement of the actuator and transmits the displacement to the plunger.

6. The droplet ejecting device according to claim 1, wherein the distal end of the plunger has a conical or polygonal pyramid shape.

7. The droplet ejecting device according to claim 1, wherein a notch is provided on a side surface of the distal end of the plunger.

8. The droplet ejecting device according to claim 1, further comprising an elastic body that covers the inner surface of the liquid chamber at a bottom portion of the liquid chamber,
wherein the distal end of the plunger is inserted with a gap inside the elastic body.

9. The droplet ejecting device according to claim 1, wherein a first region and a second region are present inside the liquid chamber, the second region is closer to a distal end side of the plunger than the first region, and a width of the second region is larger than a width of the first region.
